(19) United States
(12) Patent Application Publication
(10) Pub. No.: US 2005/0244006 A1
(43) Pub. Date: Nov. 3, 2005

(54) Record carrier with multiple built-in chips

(75) Inventors: Alphons Antonius Bruekers, Weert (NL); Antonius Hermanus Akkermans, Veldhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/529,356

(22) PCT Filed: Sep. 19, 2003
(86) PCT No.: PCT/IB03/04047

§ 371 Date: Mar. 25, 2005

(30) Foreign Application Priority Data
Sep. 30, 2002 (EP) 021023965

(51) Int. Cl. H04N 7/167

(52) U.S. Cl. 380/228

(57) ABSTRACT

The invention relates to a system for improved access control, in particular copy protec-tion, and improved personalized processing of information, the system comprising a record carrier (1) like a CD-RW+ or a DVD storing copy-protected information and a device for reading and/or writing the record carrier. For that, the record carrier (1) has a first area (3) for storing a first kind of information and further has multiple second areas (4.1, . . . , 4.8) each designed for comprising a storage medium for storing second kinds of information, these storage media preferably being implemented as chips. For copy protection, the first kind of information may be encrypted and the second kinds of information may contain decryption information. The use of multiple storage media for the second kinds of information provides for a more flexible design in distributing the storage and, preferably, computing resources over the record carrier (1). Furthermore, making the storage media detachable from the record carrier (1) results in an easy way of handling diversified access rights and personalization information.

The invention relates to a record carrier storing access-controlled, in particular copy-protected, information and/or information thought for personalized processing. Examples of such record carriers are mainly Audio CDs, CD-ROMs, CD-Rs, CD-RWs, DVDs etc., but the invention is equally applicable to other record carriers as well, as e.g. magnetic tapes, diskettes, and hard disks.

Record carriers such as CDs or DVDs are nowadays a mass product used e.g. for distributing audio and video content for entertainment purposes and to supply software and computer games. Moreover, certain kinds of these media such as the CD-R and the CD-RW+ are once or several times recordable e.g. by using a CD burner. They are therefore also usable for short-term backup as well as for long-term archiving purposes. Moreover, the increasing storage capacities of these devices extend their applicability even further.

On the other hand, the existence of these easy to handle and durable recordable media in connection with the digital representation of the media contents opened an easy way of taking one-to-one copies of copyrighted CDs, which nowadays presents a major commercial problem for the content industries. Besides this copy-protection problem the large storage capacities of these record carriers call for methods supporting the access to and the preferably personalized presentation of the information being stored on the record carriers.

Accordingly, several methods for these purposes have been proposed in the state of the art. These methods range from encrypting the content of a record carrier and preventing an easy copying of the decrypting information to access-control and personalization structures on the record carriers as well as on the corresponding reading and/or writing devices for the record carriers. E.g., among others it was proposed to use password protection, to structure the record carrier in different parts each part possessing its own access rights, and to use unique identifiers for record carriers in connection with a revocation list of the identifiers of counterfeit media. In that, the access control and/or personalization themselves might be performed by structures on the record carrier, by the reading and/or writing device for the record carrier, or in cooperation between both.

U.S. Pat. No. 6,044,046 A proposes to use a chip being physically integrated within the record carrier as a device carrying the access-control and/or personalization structures for the record carrier. This allows downward compatibility with e.g. traditional CDs and renders the record carrier with built-in chip as easy to handle as a record carrier itself. Furthermore, U.S. Pat. No. 6,044,046 A discloses the communication interfaces of the chip and of a corresponding device for reading and/or writing the record carrier with built-in chip. In particular, a solution is described for allowing the reading and/or writing device simultaneous access to the record carrier and the built-in chip. For the full description of these and related issues the contents of U.S. Pat. No. 6,044,046 A are herewith incorporated into this application by reference.

U.S. Pat. No. 6,044,046 A also mentions the necessity of establishing a high enough data transfer rate between the chip and the reading and/or writing device for enabling a smooth operation of the record carrier in the reading and/or writing device. If e.g. an optical path is used for communicating between the chip and reading and/or writing device the data bits on this path can only flow when a respective coupling element on the record carrier is in sight of the corresponding element of the reader/writer. To enable high enough data rates U.S. Pat. No. 6,044,046 A therefore proposes to use a large coupling element on the record carrier, e.g. a circular one being in continuous sight of the reader/writer's element, and/or to use multiple coupling elements distributed over the area of the record carrier seen by the reader/writer's element. Instead of making the coupling element large or use a multiplicity of them U.S. Pat. No. 6,044,046 A also foresees the possibility of a single small coupling element being coupled to an appropriate large or a multiplicity of auxiliary elements serving as transmitter and/or receiver.

While the built-in chip concept of U.S. Pat. No. 6,044,046 A offers a quite flexible solution to access control and information personalization of a record carrier such chips and the structure of its coupling and/or auxiliary elements and their connections might get somewhat complex if large amounts of access control or personalization information have to be stored and processed.

Therefore, it is an object of the invention to provide a record carrier and a corresponding device for reading and/or writing it that provides a simple and flexible way of handling even large amounts of access control or personalization information. A further object of the invention is to allow for a simple way of adding, deleting, and/or changing part of the access control or personalization information without having to deal with the unchanged part of that information.

These objects are accomplished by a record carrier having a first area for storing a first kind of information and further having multiple second areas each designed for comprising a storage medium for storing second kinds of information,
and by a device for reading and/or writing such a record carrier, wherein the device is designed for accessing the second areas.

Together, the record carrier and the device for reading and/or writing it form a system supporting access control to information and/or personalized processing of information according to the invention. Moreover, the invention provides a method for reading access controlled and/or personalized information from and/or writing such information to an inventive record carrier, the method comprising the steps of reading and/or writing the second kinds of information, and, in dependence on the second kinds of information, reading and/or writing all or part of the first kind of information.

Employing multiple second areas each with its own storage medium, preferably a chip, thus avoids the problem that a single chip might get too complex if it has to store and, if so, to process large amounts of access control or personalization information. This becomes even more obvious in considering the communication between the reader/writer and the chips. E.g., if several independent procedures and corresponding data paths are to be handled between the reader/writer and the chips, in the case of a single chip the tasks and data transfer paths have to share a single resource and, thus, have to be tightly coordinated, whereas in the case of multiple chips the tasks and data paths can simply be allocated to different chips. Of course, a task and its data need not be restricted to a single chip but might also be distributed over several ones. E.g., decryption keys may be distributed over several chips and the chips might cooperate in computing the decryption algorithms. But, in this case, obviously, these chips have to be coordinated, e.g. by the reader/writer or via a direct communication path between the chips.

Selecting an appropriate number of chips offers a flexible way to adapt to the amount and complexity of access control or personalization information that has to be handled. Moreover, adding, deleting, and/or changing part of the access control or personalization information can be restricted to the chips handling this information and thus can be done without having to deal with the unchanged part of the access control or personalization information.

Allowing the storage media, i.e. preferably the chips, to be attached or detached from the second areas, e.g. by snapping the chips into corresponding pits being milled in the second areas and fixing them by using some spring mechanism, provides a simple way of adding, deleting, or replacing such chips, thus changing the access control or personalization information in a mere “mechanical” way. These chips might e.g. be traded separately from the record carriers and might e.g. be programmed or reprogrammed using equipment only being available in specialty shops, which would yield an additional level of security against counterfeiting such chips. Accordingly, the invention also relates to such storage media and in particular to such chips being designed to be attached to an inventive record carrier.

In the same way, the invention also encompasses record carriers whose multiple second areas are devoid of any storage medium or chip but which are designed or prepared for having such storage media being attached. Such designs might e.g. consist in pits being milled in the second areas, maybe assisted by some spring mechanism, but might equally well just consist in markings of the second areas on the record carrier, a storage medium being produced on a plastic film, which is simply to be glued to the marking of a second area much like a sticker. Such attaching of storage media to the second areas of an inventive record carrier may further be simplified for a user by arranging several storage media on a single carrier, e.g. a plastic film, which is attached to the second areas of the record carrier as a single piece. Accordingly, the invention also relates to such carrier devices for storage media.

The first area of the record carrier typically serves for storing the payload information, e.g. the songs and/or videos and/or the computer games a user wants to purchase or personal information of the user as e.g. address books or mail correspondence. The second areas might also comprise pure storage media, but in a preferred embodiment comprise multiple chips as in the built-in chip concept of U.S. Pat. No. 6,044,046 A. The stores on the first and second areas might be of the same physical nature, e.g. both being a pattern of pits and lands to be read via a laser, but preferably they utilize different physical implementations, e.g. pits and lands for the first area and some simple circuitry coupled with an induction coil for the second areas. This gives the advantage of different physical channels, e.g. optical and a radio frequency ones that can be accessed in parallel. In the same manner, in some embodiments it will be advantageous to physically clearly separate the first and second areas, e.g. implementing the first area as the conventional spiral pattern of a CD and positioning the second areas between the center hole and the inner data track of the CD. This avoids mutual interference of the communication channels between the areas of the record carrier and a reading and/or writing device.

Embodying an inventive record carrier and its reading and/or writing device in a manner that the record carrier's first and second areas can be read and/or written in parallel offers the advantage that the reading and/or writing device can handle the data on the two areas independently of each other, i.e. the two data streams can be processed without disturbing each other. This offers e.g. the possibility to continuously check, e.g. at regular or irregular intervals in time, the authenticity and/or integrity of the record carrier, thus further enhancing the access control to the record carrier. E.g., if the information on the first area is encrypted and the reading and/or writing device reads the decryption information from a second area, e.g. via a radio frequency channel, only once when the record carrier is inserted in the device a hacker may betray the device by supplying the decryption information using specialized hacked equipment. This kind of attack gets much more involved if the reading and/or writing device requests the decryption information several times at e.g. irregular time intervals.

The storage media of the second areas serve for storing information of a second kind, i.e. access control and/or personalization information. This might e.g. consist of decryption information serving in encrypting and/or decrypting information to be stored on and/or to be read from the first area in an encrypted form. Or it might consist of device-access information serving in checking the right of a reading and/or writing device to access the record carrier. As further possibilities, these media might store user-specific settings serving e.g. for personalized access control or for personalized information display, or the media might store personal data as address books, correspondence, or account information on the usage of the record carrier or the data and/or programs stored on it, e.g. the scores obtained in playing a stored computer game.

Implementing the chips as processor chips offers the most flexible way of establishing advanced access control or personalization procedures. But also the simpler and cheaper possibilities of pure memory chips or even pure coupling elements already provide interesting functionality. One skilled in the art will easily observe that even a pure coupling element is able to communicate that it is there or, in case of its absence, that it is not there and, thus, carries information. Moreover, distributing the coupling elements in a deliberate manner on the record carrier can be used to encode further information in this distribution scheme. Please note, that the term coupling element is used here to denote any element (on the record carrier) whose existence is noted by the reader/writer. Thus, it encompasses the coupling elements as well as the auxiliary elements of U.S. Pat. No. 6,044,046 A.

Of course, as is obvious to one skilled in the art, one may combine the above-described measures for obtaining an even improved handling of access control to or personalization of an inventive record carrier. E.g., one may advantageously combine using very simple removable chips or even pure coupling elements with an information carrying distribution pattern of the second areas. Then, the mounting of the chips on the record carrier may e.g. serve as a regional code encoding the geographical region the record carrier is valid for.

These and further aspects and advantages of the invention will be further illustrated by the embodiments and, in particular, by the description of the attached figures.

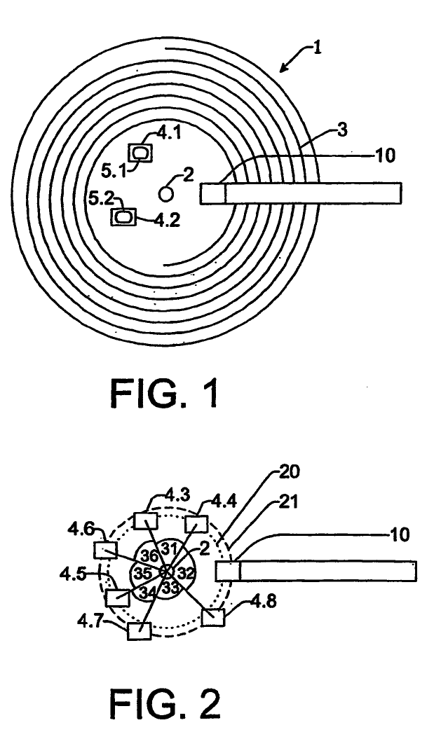

FIG. 1 shows diagrammatically an inventive record carrier and a read/write head of an inventive reader/writer.

FIG. 2 shows diagrammatically a distribution of the second areas on an inventive record carrier and a read/write head of an inventive reader/writer.

FIG. 1 shows diagrammatically an inventive record carrier 1 in the form of a disk and a read/write head 10 of an inventive reader/writer. The record carrier 1 has a central aperture 2 and a track 3. The track 3 is arranged in a spiral or concentric pattern and comprises a first area for storing information of a first kind, e.g. payload data like songs and/or videos and/or computer games or personal information of a user. Two second areas 4.1 and 4.2 for storing information of a second kind, e.g. access control and/or personalization information, are also present on the record carrier 1. The second areas 4.1 and 4.2 each comprise as their storage medium a chip, which each carries an integrated coupling element 5.1 respectively 5.2, e.g. an inductive coil or an LED and a photodiode, for communicating with the corresponding read/write head 10 of a device for reading and/or writing the record carrier 1. For more details on the general structure of the record carrier 1 and its communication means with the device for reading and/or writing it reference is again made to U.S. Pat. No. 6,044,046 A.

FIG. 2 shows diagrammatically a distribution of six second areas 4.3 through 4.8, being equipped with coupling elements not shown in the figure, on an inventive record carrier and a read/write head 10 of an inventive reader/writer. The second areas 4.3 through 4.8 are arranged on two concentric circles 20 and 21 centered on the central aperture 2 of the record carrier, i.e. the second areas 4.3, 4.4, and 4.5 lie on the inner circle 20 and second areas 4.6, 4.7, and 4.8 on the outer circle 21. Besides their position on the circles 20 or 21, the angular position of the second areas 4.3 through 4.8 on the record carrier is given by the six angles 31 through 36 formed by the connection lines of the second areas 4.3 through 4.8 with the central aperture 2.

During a revolution of the record carrier the read/write head 10 of the reader/writer will sense the relative position of the second areas 4.3 through 4.8, i.e. their position on the circles 20 or 21 and their angular positions 31 through 36. For sensing the position on the circles the read/write head 10 might e.g. be constructed as being direction dependent. For sensing the angle between two successive second areas, e.g. the angle 31 between the second areas 4.3 and 4.4 if the disk rotates clock-wise, the reader/writer may measure the time between “seeing” area 4.3 and “seeing” area 4.4, i.e. by measuring the time span between the middle points of the time intervals when being in contact with area 4.3 respectively 4.4. As the revolution speed of the record carrier typically will vary over time, of course, these absolute time spans have to be related to the duration of one revolution. Detecting that a revolution finished can e.g. be performed by giving one second area a code allowing it to be identified or by detecting the periodic re-occurrence of the second areas distribution (provided the distribution pattern avoids any periodicity within one revolution).

As the read/write head 10 is able to sense the second areas' distribution pattern this pattern can be selected to encode a third kind of information, e.g. for a regional code indicating in which geographical regions the record carrier is valid, and/or for encoding which standards the record carrier complies to, and/or for encoding if the record carrier has been inserted upside-down. This last task of detecting the orientation the record carrier has been inserted can e.g. be performed by using two second areas being on a circle at an angle to each other different from 180° and supplying one of its storage media with an identification code or by using three second areas being on a circle at non-equal angles to each other.

Instead of using the different radial positions of the second areas, i.e. their locations on circles 20 or 21, for encoding a third kind of information, such position also might be used to support different kinds of readers/writers having their read/write heads at different radial positions.

For addressing the multiple second areas in the communication between record carrier and reader/writer explicit addresses for the second areas might be used, which are communicated by the second areas at the beginning of each communication to the reader/writer. But, as described above, after one revolution of the record carrier (or a few revolutions if the periodicity recognition is used) the reader/writer knows the succession of the second areas. Thus, instead of requiring an explicit address sending the reader/writer may identify the second areas simply by their succession.

1. A record carrier (1) having a first area (3) for storing a first kind of information and further having multiple second areas (4.1, . . . , 4.8) each designed for comprising a storage medium for storing second kinds of information.

2. A record carrier (1) as claimed in claim 1, characterized in that the storage media of the first (3) and second areas (4.1, . . . , 4.8) are of a different physical kind.

3. A record carrier (1) as claimed in claim 1, characterized in that the storage medium of at least one of the second areas (4.1, . . . , 4.8) is a chip.

4. A record carrier (1) as claimed in claim 1, characterized in that at least one of the second areas (4.1, . . . , 4.8) is designed for detaching and/or attaching a storage medium to it.

5. A record carrier (1) as claimed in claim 1, characterized in that the storage medium of at least one of the second areas (4.1, . . . , 4.8) is designed for storing information relating to the access of a reading and/or writing device to the record carrier (1), in particular in that this access information comprises
encryption and/or decryption information serving in encrypting and/or decrypting information to be stored on and/or to be read from the first area (3) in an encrypted form, and/or
device-access information serving in checking the right of a reading and/or writing device to access the record carrier (1), and/or
user-specific settings serving in controlling the access of a reading and/or writing device to the record carrier (1) and/or in controlling the manner information being read from the record carrier (1) is presented by the reading and/or writing device to a user of the reading and/or writing device.

6. A record carrier (1) as claimed in claim 1, characterized in that the second areas (4.1, . . . , 4.8) are each designed to comprise a chip, the multiple chips being designed for executing a distributed procedure serving in controlling the access of a reading and/or writing device to the record carrier (1).

7. A record carrier (1) as claimed in claim 1, characterized in that the second areas (4.1, . . . , 4.8) are each designed to comprise a coupling element for data exchange between the storage medium of each second area (4.1, . . . , 4.8) and a device for reading and/or writing the record carrier (1), and in that the distribution of the coupling elements on the record carrier (1) encodes a third kind of information.

8. A storage medium being designed for storing a second kind of information and for being attached to a second area (4.1, . . . , 4.8) of a record carrier (1) as claimed in claim 1.

9. A carrier device, in particular a plastic film, with a storage medium as claimed in claim 8.

10. A device for reading and/or writing a record carrier (1) as claimed in claim 1, wherein the device is designed for accessing the second areas (4.1, . . . , 4.8).

11. A device for reading and/or writing as claimed in claim 10, characterized in that the device is designed for accessing the first (3) and at least one of the second areas (4.1, . . . , 4.8) of the record carrier (1) in parallel.

12. A device for reading and/or writing as claimed in claim 10, characterized in that the device is designed for decoding the third kind of information being encoded in the distribution of the coupling elements on a record carrier (1) as claimed in claim 7.

13. A system for supporting access control to information and/or personalized processing of information, the system comprising a device as claimed in claim 10 and a record carrier (1) as claimed in claim 1 carrying the information.

14. A method for reading and/or writing a record carrier (1) as claimed in claim 1, with the steps:
reading and/or writing the second kinds of information, and,
in dependence on the second kinds of information, reading and/or writing all or part of the first kind of information.
